(19) United States
(12) Patent Application Publication
(10) Pub. No.: US 2026/0327050 A1
(43) Pub. Date: Oct. 22, 2026

(54) CORDLESS ELECTRIC JACKING APPARATUS AND METHOD OF OPERATING THE SAME

(71) Applicant: ZHEJIANG PRULDE ELECTRIC APPLIANCE CO., LTD., Jinhua (CN)

(72) Inventors: Chenghao YANG, Jinhua (CN); Jin XU, Jinhua (CN)

(73) Assignee: ZHEJIANG PRULDE ELECTRIC APPLIANCE CO., LTD., Jinhua (CN)

(21) Appl. No.: 19/644,262

(22) Filed: Apr. 10, 2026

(30) Foreign Application Priority Data
Apr. 21, 2025 (CN) 2025104995498

(51) Int. Cl. B66F 3/46; B66F 3/44

(52) U.S. Cl. CPC B66F 3/46; B66F 3/44

(57) ABSTRACT

Disclosed are a cordless electric jacking apparatus and an operating method therefor, which relate to cordless electric jacking tools; the apparatus includes: a base, a lifting head, a telescoping assembly, an actuator assembly, a housing, and a battery pack; the actuator assembly delivers torque to the telescoping assembly to extend or retract the latter; the battery pack is removably connected to the housing to supply power at least to the actuator assembly; the center of gravity of the battery pack attached to the housing lies within the vertical projection range of the base; the torque delivered by the actuator assembly drives the telescoping assembly to cause the lifting head to ascend or descend relative to the base, thereby enabling the apparatus to lift or lower a load automatically and enhancing operational safety of the apparatus.

### FIELD

The present disclosure relates to a cordless power tool, and more particularly relates to a cordless electric jacking apparatus, and also a method of operating the cordless electric jacking apparatus.

### BACKGROUND

In industrial and everyday settings, jacking apparatuses are commonly employed for lifting loads. Conventional jacking apparatuses, such as hydraulic jacks, are typically operated manually. However, in the event of the sudden fall of the load due to an unexpected malfunction of the apparatus, the operator may be struck and severely injured, or the apparatus may sustain damage. Consequently, it is desirable to enhance operational safety in load lifting operations.

### SUMMARY

To address the above and other drawbacks in conventional technologies, the present disclosure provides a cordless electric jacking apparatus, in which an actuator assembly delivers torque to a telescoping assembly that can drive the lifting head to ascend or descend relative to the base, such that the apparatus can automatically lift or lower a load with an enhanced operation safety.

A cordless electric jacking apparatus according to the present disclosure comprises: a base; a lifting head disposed over the base; a telescoping assembly disposed between the base and the lifting head and configured to drive the lifting head to ascend or descend relative to the base; an actuator assembly configured to deliver torque to the telescoping assembly to extend or retract the telescoping assembly; a housing disposed between the base and the lifting head and configured to at least partially house the telescoping assembly and the actuator assembly; and a battery pack removably attached to the housing and configured to supply power to at least the actuator assembly, wherein the center of gravity of the battery pack, when attached to the housing, lies within the vertical projection range of the base.

In some embodiments, the battery pack attached to the housing lies within the vertical projection range of the base; and/or the lifting head lies within the vertical projection range of the base.

In some embodiments, the housing is provided with a receiving portion configured to mate with the battery pack, the battery pack being inserted from above into the receiving portion to attach to the housing.

In some embodiments, the receiving portion is disposed in a lower portion of a side wall of the housing; and/or the center of gravity of the battery pack, when attached to the housing, lies at or below a height-center line of the cordless electric jacking apparatus in its fully retracted state.

In some embodiments, the actuator assembly is disposed below the telescoping assembly, and a torque output member of the actuator assembly is oriented upward and drivingly connected to the telescoping assembly.

In some embodiments, the actuator assembly and the telescoping assembly are coaxially arranged; and/or the actuator assembly comprises an electric motor and a gearbox mounted on top of the electric motor, and a support member is disposed inside the housing positioned externally to at least a portion of the actuator assembly, the support member being configured to at least prevent the electric motor from bearing a load force.

In some embodiments, the actuator assembly is disposed laterally adjacent to the telescoping assembly, and a torque output member of the actuator assembly is oriented downward and drivingly connected to the telescoping assembly via a transmission unit.

In some embodiments, the battery pack attached to the housing and the actuator assembly are symmetrically distributed about the telescoping assembly.

The present disclosure further provides a cordless electric jacking apparatus, comprising: a base; and a lifting head disposed over the base; a telescoping assembly disposed between the base and the lifting head and configured to drive the lifting head to ascend or descend relative to the base; an actuator assembly configured to deliver torque to the telescoping assembly to extend or retract the telescoping assembly; a housing disposed between the base and the lifting head and configured to at least partially house the telescoping assembly and the actuator assembly; a battery pack removably attached to the housing and configured to supply power to at least the actuator assembly, wherein the center of gravity of the battery pack, when attached to the housing, lies within the vertical projection range of the base; and an extension rod removably installed either between the telescoping assembly and the lifting head or between the housing and the base, or both.

In some implementations, a same connection structure is employed to provide detachable connection between the telescoping assembly and the lifting head, between the housing and the base, between the extension rod and the telescoping assembly, between the extension rod and the lifting head, between the extension rod and the housing, and between the extension rod and the base.

The present disclosure further provides a first method of operating the cordless electric jacking apparatus, the cordless electric jacking apparatus being provided with a wireless communication unit, the method comprising: designating the cordless electric jacking apparatus, upon activation of its primary control function, as a primary apparatus, scanning, by the primary apparatus, for one or more further cordless electric jacking apparatuses within a predefined range, wherein the one or more further cordless electric jacking apparatuses are designated as secondary apparatuses, and communication is established between the primary apparatus and the secondary apparatuses; forwarding, by t he primary apparatus, an operational command received by the primary apparatus to the secondary apparatuses; transmitting, by the secondary apparatuses, their respective operational signals back to the primary apparatus; and comparing, by the primary apparatus, its own operational signal and the operational signals from the secondary apparatuses with a preset signal value, determining whether any operational signal from any cordless electric jacking apparatus deviates from the preset signal value, and upon determination of such deviation, issuing a command to remaining cordless electric jacking apparatuses.

The present disclosure further provides a second method of operating the cordless electric jacking apparatus, the cordless electric jacking apparatus being provided with a wireless communication unit and configured to communicate with a control terminal, the method comprising: scanning, by the control terminal, for one or more cordless electric jacking apparatuses within a predefined range, and establishing communication with the one or more cordless electric jacking apparatuses; transmitting, by the control terminal, an operational command to the one or more cordless electric jacking apparatuses in communication with the control terminal; transmitting, by the one or more cordless electric jacking apparatuses, their respective operational signals back to the control terminal, receiving, by the control terminal, operational signals from the one or more cordless electric jacking apparatuses; and detecting whether any operational signal from any cordless electric jacking apparatus deviates from a preset signal value, and upon detection of such deviation, transmitting an instruction to each of the remaining cordless electric jacking apparatuses.

The present disclosure further provides a third method of operating the cordless electric jacking apparatus, the cordless electric jacking apparatus being provided with a wireless communication unit and configured to communicate with a control terminal, the method comprising: designating the cordless electric jacking apparatus, upon activation of its primary control function, as a primary apparatus and establishing communication between the primary apparatus and the control terminal; scanning, by the primary apparatus, for one or more further cordless electric jacking apparatuses within a predefined range; designating the one or more further cordless electric jacking apparatuses as secondary apparatuses and establishing communication between the secondary apparatuses and the primary apparatus; transmitting, by the control terminal, an operational command to the primary apparatus; and forwarding, by the primary apparatus, the operational command to the secondary apparatuses.

In some embodiments, the secondary apparatuses transmit their respective operational signals back to the primary apparatus; the primary apparatus forwards its own operational signal and the operational signals from the secondary apparatuses to the control terminal; and the control terminal, upon detecting any deviation of any operational signal from any cordless electric jacking apparatus from a preset signal value, transmits an instruction to the primary apparatus itself or any of the remaining secondary apparatuses via the primary apparatus; or the secondary apparatuses transmit their respective operational signals back to the primary apparatus; and the primary apparatus, upon detecting any deviation of any operational signal from any cordless electric jacking apparatus from a preset signal value, issues an instruction to any of the remaining cordless electric jacking apparatuses.

With the technical solutions provided supra, the present disclosure offers the following benefits:
1. The cordless electric jacking apparatus provided by the present disclosure comprises a telescoping assembly, an actuator assembly, a housing, and a battery pack; the battery pack is configured to supply power to the actuator assembly; upon activation, the actuator assembly delivers torque to the telescoping assembly, driving the latter to extend or retract, thereby enabling the lifting head to ascend or descend relative to the base and lifting or lowering a load supported by the apparatus. This electrically driven mechanism automates the ascending/descending process of the apparatus, eliminates the need for manual operation, and significantly enhances operational safety during load lifting. Furthermore, the use of the battery pack eliminates dependency on an external power source, thereby expanding the apparatus's applicability to diverse environments.

When the battery pack is attached to the housing, the center of gravity of the battery pack lies within the vertical projection range of the base. By optimizing the position of the battery pack relative to the base so that the battery pack is disposed as close to the center of the base as possible, the apparatus can achieve stable placement, reducing the risk of tipping over as would otherwise occur if the battery pack is positioned too far from the base resulting in deviation of the center of gravity of the apparatus from the center of the base; therefore, the present disclosure enhances stability of the apparatus when supporting or lifting a load.
2. When the battery pack is attached to the housing, the battery pack is preferably positioned entirely within the vertical projection range of the base, further optimizing its proximity to the center of the base. This arrangement thereby further enhances the apparatus's placement stability.

The lifting head is preferably located within the vertical projection range of the base. The positional relationship between the lifting head and the base is appropriately configured to allow the weight of the load to be transmitted downward through the lifting head to the base, thereby improving load balance and enhancing stability during load support. This arrangement prevents load imbalance caused by an offset between the lifting head and the base, which could otherwise lead to apparatus tipping or structural damage under load.
3. The housing is provided with a receiving portion, and the battery pack is preferably inserted from above into the receiving portion. The battery pack is removably attached to the housing via engagement with the receiving portion. The engagement relationship facilitates mounting and removal of the battery pack. Additionally, since the battery pack is inserted from above into the receiving portion, unintended loosening of the battery pack relative to the housing is prevented during handling or operation of the apparatus, thereby enhancing attachment stability of the battery pack inserted into the housing.
4. Since the receiving portion is disposed in the lower portion of a side wall of the housing, the attached battery pack is also positioned in the lower portion of the housing. This configuration effectively lowers the center of gravity of the entire apparatus, thereby enhancing stability of the apparatus during freestanding or load-supporting operations.

When the battery pack is attached to the housing, its center of gravity lies at below the height-center line of the apparatus in its fully retracted state, so that the battery pack is disposed as low as possible relative to the entirety of the apparatus, which may lower the overall center of gravity of the apparatus and thus enhance stability of the apparatus during freestanding or load-supporting operations.
5. The actuator assembly may be disposed below the telescoping assembly, with the torque output member of the actuator assembly oriented upward and drivingly connected to the telescoping assembly. This configuration shortens the transmission distance between the actuator assembly and the telescoping assembly, thereby reducing the minimum overall height of the apparatus.
6. The actuator assembly and the telescoping assembly are preferably coaxially arranged. This coaxial arrangement simplifies the transmission structure therebetween and helps control the overall radial dimensions of the apparatus.

The actuator assembly comprises an electric motor and a gearbox. A support member is disposed within the housing positioned externally to at least a portion of the actuator assembly, configured to at least prevent the electric motor from bearing a load force, thereby preventing damage to the electric motor, ensuring structural stability and performance consistency of the electric motor, which in turn contributes to the operational longevity and performance reliability of the entire apparatus.
7. Alternatively, the actuator assembly may be positioned laterally of the telescoping assembly, with the torque output member oriented downward and drivingly connected to the telescoping assembly via a transmission unit. Furthermore, the battery pack and the actuator assembly are symmetrically distributed about the telescoping assembly. This arrangement achieves lateral weight distribution balance, thereby enhancing the apparatus' overall stability.
8. A further configuration of the cordless electric jacking apparatus according to the present disclosure comprises an extension rod that may be installed between the telescoping assembly and the lifting head and/or between the housing and the base; this extension rod may effectively extend the lifting height of the apparatus. The user may determine whether to install it depending on specific operational requirements.
9. In the first method of operating the cordless electric jacking apparatus according to the present disclosure, the apparatuses within a predefined range may communicate with each other via a wireless communication unit, where the apparatus with its primary control function activated is designated as a primary apparatus, while the remaining apparatuses are designated as secondary apparatuses; The primary apparatus can forward an operational command received from a user to the secondary apparatuses, enabling synchronized operation across all apparatuses and ensuring stable lifting or lowering of the load. The secondary apparatuses transmit their respective operational signals back to the primary apparatus; upon detecting any deviation of any operational signal from any cordless electric jacking apparatus from a preset signal value, the primary apparatus can issue an instruction, for example, slowing down or pausing, to the remaining apparatuses, so that all apparatuses may maintain substantially consistent height across their lifting heads, thereby ensuring that the load can be lifted or lowered stably by the multiple apparatuses.
10. In the second method of operating the cordless electric jacking apparatus according to the present disclosure, all apparatuses within a predefined range can communicate with a control terminal, so that the control terminal can transmit an operational command simultaneously to all apparatuses; the apparatuses operate synchronously as per the operational command to stably lift or lower the load. Each of the apparatuses transmits their respective operational signals back to the control terminal; upon detecting any deviation of any operational signal from any cordless electric jacking apparatus from a preset signal value, the control terminal issues a command to the remaining apparatuses, e.g., instructing them to slow down or pause; consequently, all of the apparatuses can maintain a substantially consistent height across their lifting heads, enabling the load to be lifted or lowered stably by the multiple apparatuses.
11. In the third method of operating the cordless electric jacking apparatus according to the present disclosure, one apparatus with its primary control function activated is designated as the primary apparatus that can communicate with a control terminal, while one or more further apparatuses within a predefined range are designated as secondary apparatuses that communicate with the primary apparatus. The control terminal transmits an operational command to the primary apparatus, which forwards the operational command to the secondary apparatuses, enabling all apparatuses to operate synchronously as per the operational command, so that the load can be lifted or lowered stably by multiple apparatuses. In one embodiment, the secondary apparatuses transmit their respective operational signals back to the primary apparatus, which transmits its own operational signal and the operational signals received from the secondary apparatuses to the control terminal; upon detecting any deviation of any operational signal from any cordless electric jacking apparatus from a preset signal value, the control terminal issues an instruction to slow down or pause to the secondary apparatuses via the primary apparatus, enabling all apparatuses to maintain a substantially consistent height across their lifting heads, so that the load can be lifted or lowered stably by multiple apparatuses. In another embodiment, the secondary apparatuses transmit their respective operational signals back to the primary apparatus; upon detecting any deviation of any operational signal from any cordless electric jacking apparatus from a preset signal value, the primary apparatus may directly issue an instruction to the remaining apparatuses, e.g., an instruction to slow down or pause, enabling all apparatuses to maintain a substantially consistent height across their lifting heads, so that the load can be lifted or lowered stably by multiple apparatuses.

### BRIEF DESCRIPTION OF THE DRAWINGS

FIG. 1 is an overall structural view of a cordless electric jacking apparatus according to a first embodiment;

FIG. 2 is a structural view of the cordless electric jacking apparatus without a battery pack according to the first embodiment;

FIG. 3 is a side view of the cordless electric jacking apparatus according to the first embodiment;

FIG. 4 is a cross-sectional view of the cordless electric jacking apparatus according to the first embodiment, taken along the left-right direction;

FIG. 5 is a cross-sectional view of the cordless electric jacking apparatus according to the first embodiment, taken along the front-rear direction;

FIG. 6 is a cross-sectional view of a local structure of the cordless electric jacking apparatus according to the first embodiment;

FIG. 7 is a local structural view of the cordless electric jacking apparatus according to the first embodiment;

FIG. 8 is a structural view showing a support member and a lower connector the first embodiment;

FIG. 9 is an electrical schematic diagram of the cordless electric jacking apparatus according to the first embodiment;

FIG. 10 is a schematic diagram of the cordless electric jacking apparatus when supporting a load according to the first embodiment;

FIG. 11 is a flowchart of an operational method according to the first embodiment;

FIG. 12 is a communication schematic diagram illustrating collaborative control of multiple cordless electric jacking apparatuses according to the first embodiment;

FIG. 13 is a cross-sectional view of a local structure of a cordless electric jacking apparatus with a first configuration of a support member according to a second embodiment;

FIG. 14 is a cross-sectional view of a local structure of the cordless electric jacking apparatus according to the second embodiment, when the support member adopts a second solution;

FIG. 15 is a structural view of a cordless electric jacking apparatus according to a third embodiment;

FIG. 16 is a cross-sectional view of a local structure of the cordless electric jacking apparatus according to the third embodiment;

FIG. 17 is a structural view of a cordless electric jacking apparatus according to a fourth embodiment;

FIG. 18 is a structural view showing a lifting head, an extension rod and part of a telescoping assembly according to the fourth embodiment;

FIG. 19 is a structural view of a base, an extension rod and part of a housing according to the fourth embodiment;

FIG. 20 is a flow schematic diagram of an operational method according to a fifth embodiment;

FIG. 21 is a communication schematic diagram illustrating collaborative control of multiple cordless electric jacking apparatuses according to the fifth embodiment;

FIG. 22 is a flowchart of an operational method according to a sixth embodiment;

FIG. 23 is a communication schematic diagram illustrating collaborative control of multiple cordless electric jacking apparatuses according to the sixth embodiment.

In the drawings: 10—cordless electric jacking apparatus; 10A—primary apparatus; 10B—secondary apparatus; 101—connecting structure; 100—base; 110—lower mounting hole; 120—lower coupling sleeve; 130—first resilient pad; 200—lifting head; 210—upper mounting hole; 220—upper coupling sleeve; 230—cover; 240—second resilient pad; 300—telescoping assembly; 310—lead screw; 320—nut; 330—inner tube; 340—outer tube; 351—first sensor; 352—second sensor; 360—support plate; 370—end cover; 380—limit washer; 400—actuator assembly; 410—electric motor; 411—drive shaft; 420—gearbox; 421—reduction mechanism; 422—gearbox housing; 4221—gearbox shell; 4222—gearbox cover; 4223—recess; 4224—flange; 430—torque output member; 431—output shaft; 440—sun gear; 450—support disc; 500—housing; 510—receiving portion; 520—lower connector; 521—connection portion; 522—positioning portion; 523—positioning block; 530—rib; 600—battery pack; 710—control board; 720—control panel; 730—control element; 740—primary control button; 750—wireless communication unit; 800—support member; 810—support portion; 910—transmission unit; 911—driving gear; 912—driven gear; 920—outer casing; 921—upper housing; 922—lower housing; 1000—extension rod; 1010—externally threaded section; 1020—internally threaded section; 20—load; 30—control terminal.

### DETAILED DESCRIPTION OF EMBODIMENTS

Hereinafter, the present disclosure will be further described through exemplary embodiments referring to the accompanying drawings. It is to be understood that the orientational or positional relationships indicated by the terms “upper,” “lower,” “left,” “right,” “longitudinal,” “transverse,” “inner,” “outer,” “vertical,” “horizontal,” “top,” “bottom,” etc. are orientational and positional relationships based on the drawings, which are intended only for facilitating description of the disclosure and simplifying relevant illustrations, not for indicating or implying that the devices or elements compulsorily possess those specific orientations and are compulsorily configured and operated with those specific orientations; therefore, such terms should not be construed as limitations to the disclosure.

### First Embodiment

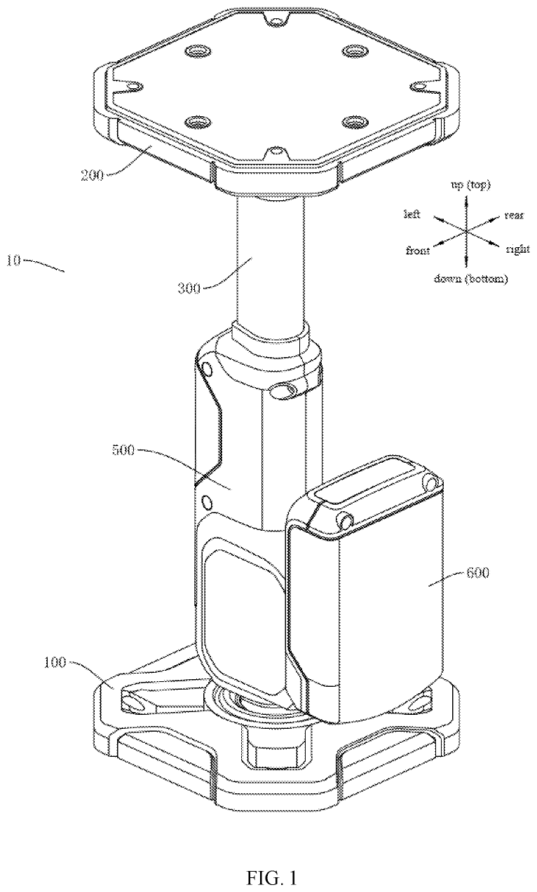

Referring to FIGS. 1 to 9, a cordless electric jacking apparatus 10 according to the first embodiment comprises:
a base 100;
a lifting head 200 disposed over the base 100;
a telescoping assembly 300 disposed between the base 100 and the lifting head 200 and configured to drive the lifting head 200 to ascend or descend relative to the base 100;
an actuator assembly 400 configured to deliver torque to the telescoping assembly 300 to effect extension or retraction thereof;
a housing 500 disposed between the base 100 and the lifting head 200 and configured to at least partially house the telescoping assembly 300 and the actuator assembly 400;
and a battery pack 600 removably attached to the housing 500 and configured to at least supply power to the actuator assembly 400, the center of gravity of the battery pack 600 being located within the vertical projection range of the base 100 when the battery pack 600 is attached to the housing 500.

In the cordless electric jacking apparatus 10 provided in this embodiment, the battery pack 600 is configured to supply power to the actuator assembly 400. When energized, the actuator assembly 400 delivers torque to the telescoping assembly 300 to effect extension or retraction thereof, driving the lifting head 200 to ascend or descend relative to the base 100, thereby enabling a load supported by the apparatus to rise or fall. This electrically-driven, automatic lifting of the apparatus eliminates manual operation and thus significantly enhances operational safety of the load-jacking apparatus. In addition, since the apparatus is powered by the battery pack 600, its operating location is not restricted by the availability of an external power supply, thereby effectively expanding the apparatus's application scenarios. The center of gravity of the battery pack 600 is positioned within the vertical projection range of the base 100. Positioning the battery pack 600 relative to the base 100 such that it is disposed as close to the center of the base 100 as possible ensures stable placement of the apparatus, reducing the risk of tipping as would otherwise occur if the battery pack 600 is disposed too distant from the base 100 resulting in deviation of the center of gravity of the apparatus from the center of the base; therefore, the present disclosure enhances stability of the apparatus when supporting or lifting a load.

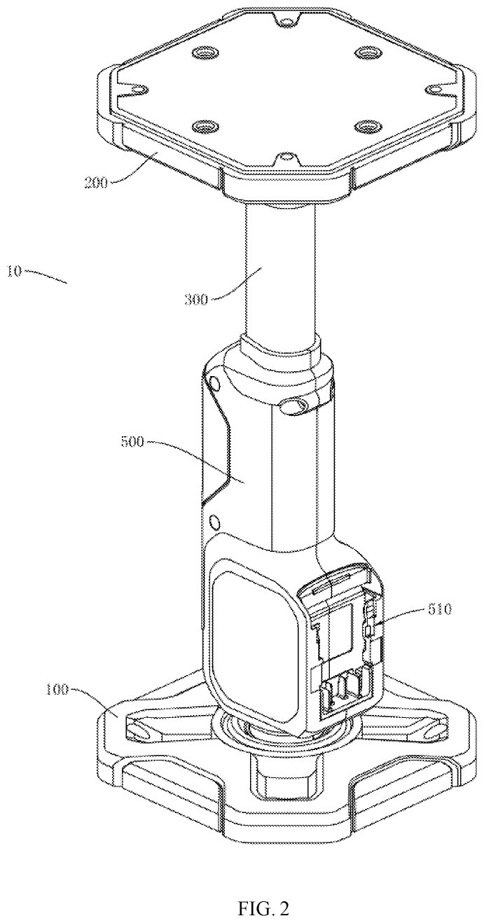

Referring to FIGS. 1 and 2, in this embodiment, the base 100 and the lifting head 200 are both of a plate or block-shaped structure with a defined surface area. The telescoping assembly 300, the actuator assembly 400, the housing 500, and the battery pack 600 are vertically disposed between the lifting head 200 and the base 100, a lower end of the housing 500 being connected to the base 100, the actuator assembly 400 extending upward from the housing 500, the lifting head 200 being connected to a movable member of the telescoping assembly 300.

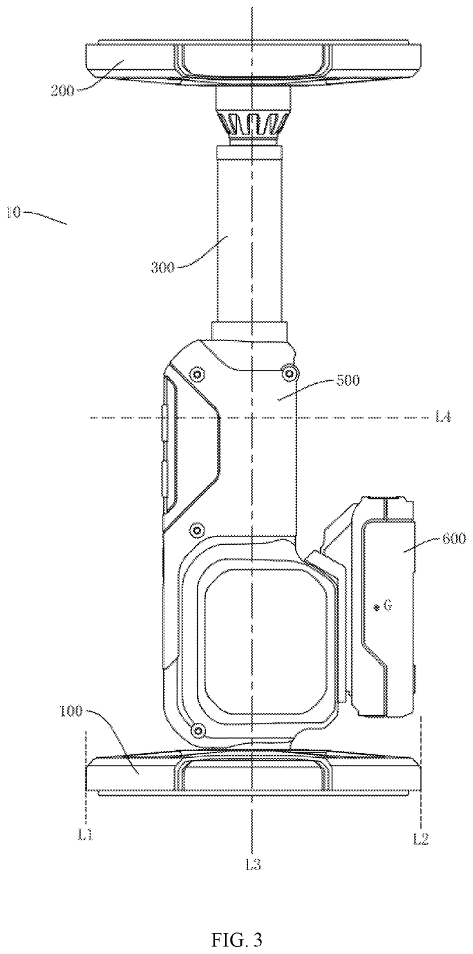

Referring to FIG. 3, point G denotes the center of gravity of the battery pack 600, lines L1 and L2 represent the vertical projection range boundary lines of the base 100. Point G lies horizontally between lines L1 and L2, ensuring that the center of gravity of the battery pack 600 remains within the vertical projection range of the base 100 when the battery pack 600 is attached to the housing 500. Furthermore, in FIG. 3, line L3 indicates the center line of the base 100, and point G (the center of gravity of the battery pack 600) lies between lines L2 and L3, i.e., the battery pack 600 attached to the housing 500 is offset relative to the base 100 while the center of gravity of the battery pack 600 remains within the vertical projection range of the base 100.

Furthermore, when the battery pack 600 is attached to the housing 500, its entire structure preferably lies within the vertical projection range of the base 100, so that the battery pack 600 attached to the housing 500 is disposed as close to the center of the base 100 as possible, which further enhances placement stability of the apparatus. As shown in FIG. 3, when the battery pack 600 is attached to the housing 500, the vertical projection range of the battery pack 600 lies entirely between lines L2 and L3, ensuring that the battery pack 600 remains entirely within the vertical projection range of the base 100. Of course, in an alternative solution of the present application, when the battery pack 600 is attached to the housing 500, it is allowed that only a portion of the battery pack 600 proximal the center of the base 100 lies within the vertical projection range of the base 600, while the portion offset from the center of the base 100 lies outside of the vertical projection range of the base 100.

In this embodiment, a side portion of the housing 500 is provided with a receiving portion 510, the battery pack 600 being removably attached to the side portion of the housing 500 by fitting into the receiving portion 510. Furthermore, when the battery pack 600 is attached to the housing 500, it is mounted from above into the receiving portion 510 to prevent loosening of the battery pack 600 relative to the housing 500 during handling or operation of the apparatus, thereby improving attachment stability of the battery pack 600 to the housing 500. Optionally, the housing 500 may adopt a split-shell structure, with the receiving portion 510 disposed on the left or right side of the housing 500.

In this embodiment, the receiving portion 510 is preferably provided in a lower portion of a side wall of the housing 500, and the battery pack 600, when attached to the housing 500, is also positioned within the lower portion of the housing 500, ensuring that the battery pack 600 attached to the housing 500 is positioned relatively low on the housing 500. This configuration effectively lowers the overall center of gravity of the apparatus, enhancing the apparatus's stability during freestanding or load-supporting operations.

Furthermore, when the battery pack 600 is attached to the housing 500, the center of gravity of the battery pack 600 preferably lies at or below the height-center line of the cordless electric jacking apparatus 10 in its fully retracted state. The fully retracted state refers to the state in which the telescoping assembly 300 is at its shortest length, resulting in the minimum vertical distance between the lifting head 200 and the base 100. As shown in FIG. 3, line L4 represents the height-center line of the apparatus in its fully retracted state. When the battery pack 600 is attached to the housing 500, the center of gravity (point G) is positioned either below line L4 or coincides with line L4. Furthermore, the entirety of the battery pack 600 attached to the housing 500 lies at or below line L4, i.e., the entirety of the battery pack 600 lies at or below the height-center line of the apparatus in its fully retracted state; this ensures the battery pack 600 remains positioned as low as possible relative to the entirety of the apparatus, further lowering the overall center of gravity of the apparatus. This configuration enhances the stability of the apparatus during freestanding or load-support operations and simultaneously prevents the lifting head 200 from interfering with mounting of the battery pack 600.

In this embodiment, the centers of the lifting head 200 and the base 100 are preferably aligned, and the lifting head 200 is preferably located within the vertical projection range of the base 100. The positional relationship between the lifting head 200 and the base 100 is configured to enable downward transmission of the weight of the load through the lifting head 200 to the base 100, thereby improving the overall load balance of the apparatus and enhancing stability during load-supporting operations. This arrangement prevents load imbalance caused by an offset between the lifting head 200 and the base 100, which could otherwise lead to apparatus tipping or structural damage under load. Specifically, in this embodiment, the lifting head 200 and the base 100 have substantially identical shapes and sizes, resulting in their vertical projection ranges being substantially coincident. Of course, in an alternative embodiment of the present application, the lateral area of the lifting head 200 may be smaller than that of the base 100, such that the vertical projection range of the lifting head 200 is smaller than that of the base 100. Additionally, the shapes of the lifting head 200 and the base 100 may differ. In further alternative embodiments of the present application, the centers of the lifting head 200 and the base 100 may be offset by a certain distance.

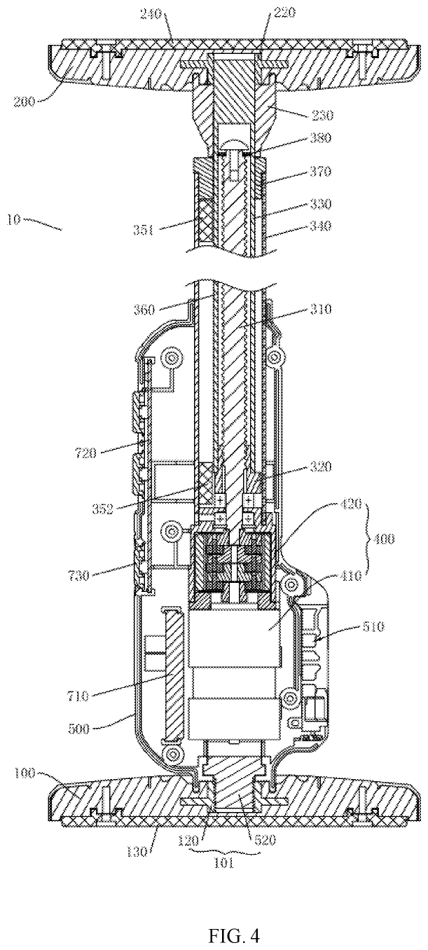

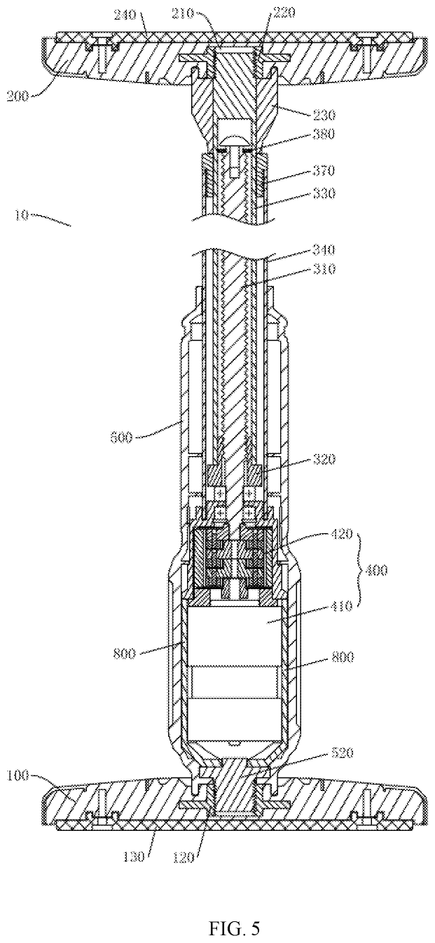

Referring to FIGS. 4 and 5, in this embodiment, the telescoping assembly 300 comprises a lead screw 310, a nut 320, an inner tube 330, and an outer tube 340; the lead screw 310 is vertically oriented and rotatable about its own central axis under actuation by the actuator assembly 400; the nut 320 is threadedly fitted onto the lead screw 310 and axially movable relative to the lead screw 310; the inner tube 330 is coaxially mounted around the lead screw 310, a lower end of the inner tube 330 being connected to the nut 320, an upper end of the inner tube 330 being connected to the lifting head 200; the outer tube 340 is coaxially positioned around the inner tube 330 and fixed in place. When the lead screw 310 rotates in a first direction, the nut 320 is driven to move upward via its threaded engagement with the lead screw 310, and the upward movement of the nut 320, in turn, brings the lifting head 200 to move upward synchronously via the inner tube 330, thereby lifting the load supported by the apparatus. Conversely, when the lead screw 310 rotates in a second direction opposite to the first direction, the nut 320 is driven to move downward via its threaded engagement with the lead screw 310, and the downward movement of the nut 320 brings the lifting head 200 to move downward synchronously via the inner tube 330, thereby lowering the load supported by the apparatus or returning the entire apparatus to its fully retracted state. In this embodiment, one of the first direction and the second direction refers to clockwise rotation, while the other one thereof refers to counterclockwise rotation. Specifically, the lower end of the inner tube 330 may be fixedly mounted around the nut 320 to establish the connection between the inner tube 330 and the nut 320, or secured to the nut 320 via a fastener or other means. This embodiment does not impose a limitation on the specific connection method between the inner tube 330 and the nut 320, provided the two can move synchronously. Additionally, the connection between the inner tube 330 and the nut 320 may circumferentially constrain the nut 320, ensuring that the nut 320 undergoes axial movement only without rotational displacement during rotation of the lead screw 310, thereby enabling the apparatus to smoothly lift and lower the supported load during operation.

Referring to FIG. 4, the cordless electric jacking apparatus 10 further comprises a control board 710 provided in the housing 500. Furthermore, to control a telescoping stroke of the telescoping assembly 300, the telescoping assembly 300 further comprises a first sensor 351 and a second sensor 352 mounted on a support plate 360 inside the outer tube 340, the first sensor 351 and the second sensor 352 being in signal communication with and/or electrically connected to the control board 710, enabling the control board 710 to regulate the actuator assembly 400 based on feedback signals from the sensors. In this embodiment, the support plate 360 is elongated and, vertically mounted between the outer tube 340 and the inner tube 330, the first sensor 351 and the second sensor 352 being respectively located at the upper and lower ends of the support plate 360. When upward movement of the nut 320 and the inner tube 330 triggers the first sensor 351, the control board 710 interprets the trigger signal from the first sensor 351 as indicating that the nut 320 and inner tube 330 have reached their upper limit, and then the control board 710 commands the actuator assembly 400 to stop actuation or reverse direction, preventing further upward movement of the nut 320 and the inner tube 330. Similarly, when downward movement of the nut 320 and the inner tube 330 triggers the second sensor 352, the control board 710 interprets the trigger signal from the second sensor 352 as indicating that the nut 320 and inner tube 330 have reached their lower limit, and then the control board 710 commands the actuator assembly 400 to stop or reverse direction, preventing further downward movement of the nut 320 and the inner tube 330. Specifically, the first sensor 351 and the second sensor 352 may be configured as microswitches. In such cases, a protrusion for triggering the microswitches can be provided on the nut 320 or the inner tube 330, or an exposed portion of the nut 320 extending beyond the inner tube 330 can also be leveraged to trigger the microswitches. The first sensor 351 and the second sensor 352 may also be configured as magnetic sensors such as reed switches or Hall-effect sensors, with corresponding, magnets mounted on the nut 320 or the inner tube 330 to trigger the magnetic sensors. In another configuration, the first sensor 351 and the second sensor 352 may be photoelectric sensors; in such cases, features configured to trigger the optoelectrical sensors may be arranged on the nut 320 or the inner tube 330. This embodiment does not impose a specific limitation on types or models of the first sensor 351 and second sensor 352, provided they meet the stroke detection requirements of the telescoping assembly 300. The first sensor 351 and second sensor 352 may be of identical or different types.

In this embodiment, the lower portion of the outer tube 340 is received within the housing 500. A plurality of ribs 530 which are spaced apart and configured to radially constrain the outer tube 340 and the actuator assembly 400 are provided on the inner wall of the housing 500, thereby enhancing structural stability of relevant components. The telescoping assembly 300 further comprises an end cover 370 secured to an upper end of the outer tube 340, the end cover 370 being clearance-fitted around the inner tube 330. On one hand, the end cover 370 seals the upper end of the outer tube 340, preventing external contamination from entering the telescoping assembly 300; on the other hand, the end cover 370 constrains the inner tube 330 radially, preventing radial displacement of the inner tube 330 during operation, thereby ensuring movement stability of the telescoping assembly 300. Additionally, a limit washer 380 is secured to the upper end of the lead screw 310 via a screw, an outer diameter of the limit washer 380 being greater than that of the lead screw 310 but slightly smaller than an inner diameter of the inner tube 330. The clearance fit between the limit washer 380 and the inner tube 330 further radially constrains the lead screw 310, preventing radial displacement of the lead screw 310 during operation and ensuring movement stability of the telescoping assembly 300.

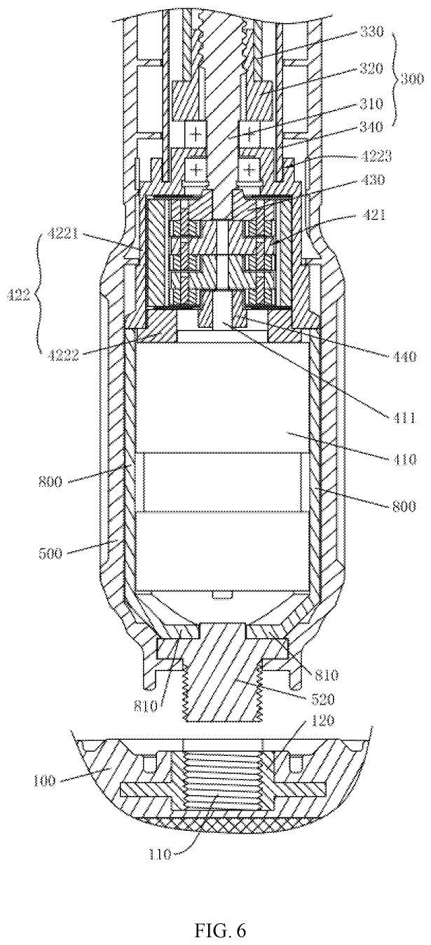

Referring to FIG. 6, in this embodiment, the actuator assembly 400 is provided with a torque output member 430. The actuator assembly 400 delivers torque to the lead screw 310 via the torque output member 430, enabling the lead screw 310 to rotate in either a first direction or a second direction. The actuator assembly 400 comprises an electric motor 410 and a gearbox 420, the torque output member 430 being positioned within the gearbox 420. The gearbox 420 comprises a gearbox housing 422 and a reduction mechanism 421 disposed within the gearbox housing 422. The reduction mechanism 421 is disposed between a drive shaft 411 of the electric motor 410 and the torque output member 430 and comprises at least one reduction stage.

Referring to FIG. 6, in this embodiment, the actuator assembly 400 is positioned beneath the telescoping assembly 300. The torque output member 430 is oriented upward and drivingly coupled to the telescoping assembly 300. This configuration effectively shortens the transmission distance between the actuator assembly 400 and the telescoping assembly 300, thereby reducing the overall minimum height of the apparatus. Specifically, the electric motor 410 is vertically oriented and mounted in the lower portion of the housing 500, and the gearbox 420 is vertically positioned on top of the electric motor 410. The electric motor 410 comprises a drive shaft 411, a sun gear 440 being mounted on an upper end of the drive shaft 411. The reduction mechanism 421 within the gearbox 420 is implemented as a one-stage, two-stage, or multi-stage planetary gear reduction structure, a planet carrier of the final-stage planetary gear reduction structure being positioned at the upper end of the reduction mechanism 421, the planet carrier serving as the torque output member 430. The lower end of the lead screw 310 extends into the gearbox 420 and is supported by a bearing. The lower end of the lead screw 310 is drivingly coupled to the planet carrier of the final-stage planetary gear reduction structure. During operation of the electric motor 410, the drive shaft 411 drives the sun gear 440 to rotate synchronously. The sun gear 440 drives the planetary carrier of the final-stage planetary gear reduction structure to rotate via intermediate stages of the planetary gear reduction structure, which in turn rotates the lead screw 310 synchronously. This enables the actuator assembly 400 to deliver torque to the telescoping assembly 300. Specifically, the lower end of the lead screw 310 and the planet carrier of the final-stage planetary gear reduction structure may be drivingly coupled via splined engagement, non-circular shaft-bore engagement, or a fastener. Additionally, the planetary stages within the gearbox 420 may share a common ring gear or each stage may have its respective ring gear. In alternative embodiments of the present application, the torque output member 430 may also be an output shaft mounted on the planet carrier of the final-stage planetary gear reduction structure of the gearbox 420. In such cases, the lower end of the lead screw 310 is drivingly coupled to the output shaft via a coupling or like mechanical linkage.

The gearbox housing 422 of the gearbox 420 comprises a gearbox shell 4221 and a gearbox cover 4222 mounted at a lower end of the gearbox shell 4221. The outer tube 340 of the telescoping assembly 300 extends downward into the housing 500 to abut against the gearbox housing 422, thereby axially constraining the outer tube 340. To further enhance stability of the outer tube 340, a circumferential recess 4223 is formed at the upper end of the gearbox housing 422, a lower end of the outer tube 340 being inserted into the recess 4223, enabling the recess 4223 to radially constrain the lower end of the inner tube 330. Additionally, when the outer tube 340 is a non-circular tube, the recess 4223 can also impose a circumferential constraint on the inner tube 330.

In this embodiment, the actuator assembly 400 and the telescoping assembly 300 are preferably coaxially arranged, facilitating simplification of the transmission structure between the actuator assembly 400 and the telescoping assembly 300 and enabling effective control of the overall radial dimension of the apparatus. Furthermore, the central axes of the electric motor 410, the gearbox 420, and the telescoping assembly 300 are substantially aligned. Specifically, the central axis of the electric motor 410 is defined by the central axis of its drive shaft 411, the central axis of the gearbox 420 is defined by the central axis of the torque output member 430, and the central axis of the telescoping assembly 300 is defined by the central axis of the lead screw 310. Additionally, the centers of the base 100, the lifting head 200, the actuator assembly 400, and the telescoping assembly 300 are preferably aligned. In alternative embodiments of the present application, the central axes of the electric motor 410 and the gearbox 420 may be offset from each other, and the central axes of the gearbox 420 and the telescoping assembly 300 may also be offset.

Referring to FIG. 6, in this embodiment, a connecting structure 101 is provided between the lower end of the housing 500 and the base 100. Specifically, a lower connector 520 is fixed to the lower end of the housing 500, and a lower coupling sleeve 120 is disposed on the base 100 to mate with the lower connector 520. The lower coupling sleeve 120 defines a lower mounting hole 110 that corresponds to the lower connector 520, enabling the lower end of the housing 500 to be connected to the base 100 via engagement between the lower connector 520 and the lower coupling sleeve 120. Furthermore, the lower connector 520 may be clasped by the housing 500, while the lower coupling sleeve 120 is embedded within the base 100. The threaded engagement between the lower connector 520 and the lower coupling sleeve 120 allows for a detachable connection, facilitating component replacement. To ensure structural stability and longevity, the lower connector 520 and the lower coupling sleeve 120 may be fabricated from metallic materials such as stainless steel, while the housing 500 and the base 100 may be constructed from high-strength plastic. The metallic lower coupling sleeve 120 can be secured on the base 100 via over-molding or like processes. In an alternative embodiment of the present application, the lower coupling sleeve 120 may be canceled, the lower connector 520 may be secured on the base 100 via over-molding or like processes, and the housing 500 clamps the lower connector 520; consequently, the housing 500 and the base 100 can be connected solely via the lower connector 520.

Referring to FIG. 5, in this embodiment, the lifting head 200 is provided thereon with an upper mounting hole 210 configured to mate with a top end of the inner tube 330, the top end of the inner tube 330 being engaged with the upper mounting hole 210 to realize connection between the telescoping assembly 300 and the lifting head 200. Specifically, the lifting head 200 is provided thereon with an upper coupling sleeve 220, the upper mounting hole 210 being defined on the upper coupling sleeve 220. Furthermore, the top end of the inner tube 330 and the upper coupling sleeve 220 may be removably connected via threaded engagement. To ensure structural stability and component longevity, the inner tube 330 and the upper coupling sleeve 220 may be fabricated from metallic materials such as stainless steel, while the lifting head 200 may be constructed from high-strength plastic. The metallic upper coupling sleeve 220 can be secured on the lifting head 200 via over-molding or like processes. A cover 230 fitted around an outer periphery of the top end of the inner tube 330 is mounted on an underside of the lifting head 200. The cover 230 serves a decorative purpose. When the apparatus is in its fully retracted state, the bottom surface of the cover 230 is positioned slightly elevated relative to the top surface of the end cover 370, preventing compression between the cover 230 and the end cover 370. In alternative embodiments of the present application, the top end of the inner tube 330 and the lifting head 200 may be connected by other means, for example a flanged connection with a fastener.

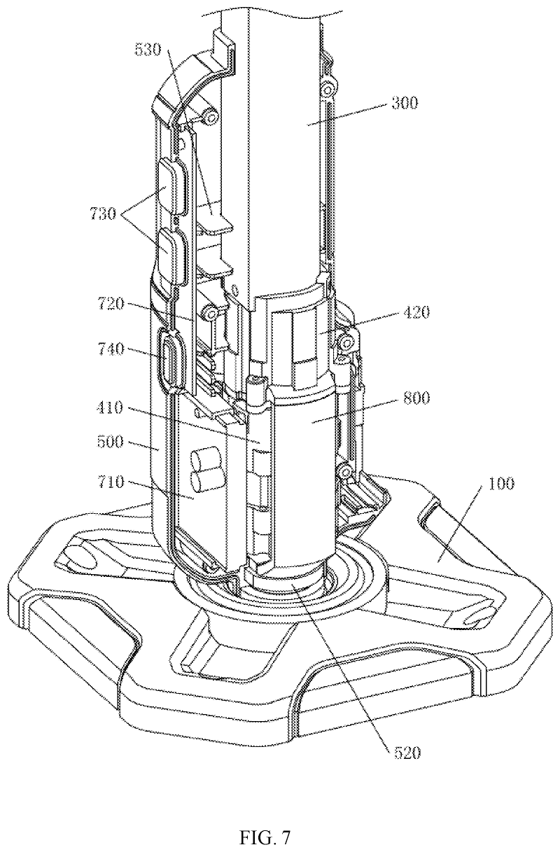

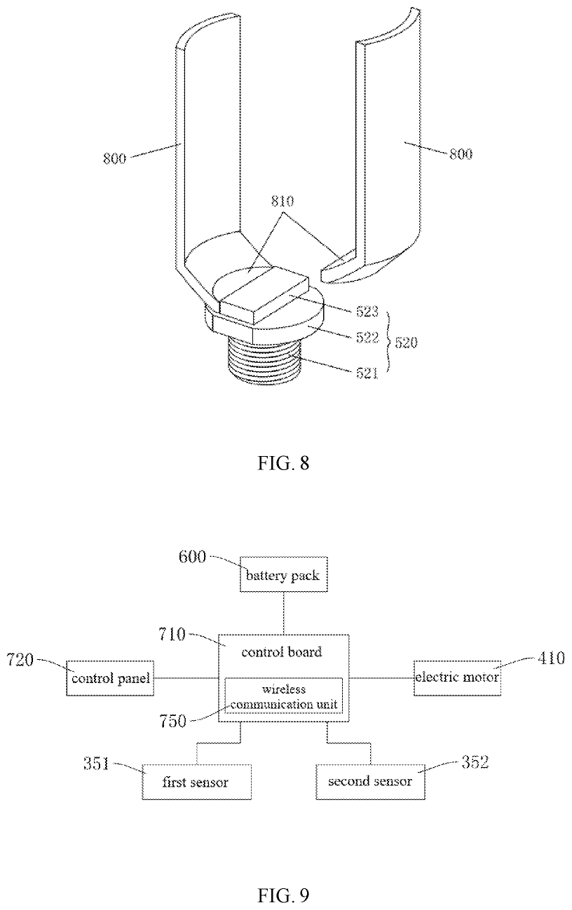

Referring to FIGS. 7 and 8, in the this embodiment, a support member 800 is disposed within the housing 500 positioned externally to at least a portion of the actuator assembly 400, configured to at least prevent the electric motor 410 from bearing a load force, thereby preventing damage to the electric motor 410, ensuring structural stability and performance consistency of the electric motor 410, which in turn guarantees the longevity and performance consistency of the entire apparatus. Furthermore, the support member 800 is disposed externally to the electric motor 410. A lower end of the telescoping assembly 300 abuts against the gearbox housing 422 directly or indirectly; the gearbox housing 422 directly or indirectly abuts against an upper end of the support member 800; and a lower end of the support member 800 abuts against the base 100 directly or indirectly. When the apparatus supports a load, the load force borne by the lifting head 200 is transmitted downward to the base 100 via the telescoping assembly 300, the gearbox housing 422, and the support member 800, thereby effectively preventing the electric motor 410 from bearing the load force. Specifically, two support members 800 are symmetrically arranged circumferentially about the electric motor 410, each support member 800 exhibiting a substantially arc-shaped cross-sectional profile perpendicular to a height direction. The upper end of each support member 800 directly abuts against a lower end of the gearbox shell 4221. The lower end of each support member 800 is provided with a support portion 810, the support portion 810 being bent inward toward the axial center of the electric motor 410 and of a substantially block shape; this support portion 810 is in abutment with the lower connector 520. When the housing 500 and the base 100 are connected via engagement between the lower connector 520 and the lower coupling sleeve 120, the support portion 810 at the lower end of the support member 800 indirectly abuts against the base 100 via the lower connector 520 and the lower coupling sleeve 120. Of course, an elastic sealing gasket or a rigid support ring may be disposed between the upper end of the support member 800 and the lower end of the gearbox shell 4221, enabling the gearbox shell 4221 of the gearbox housing 422 to indirectly abut against the upper end of the support member 800. Additionally, the lower end of the support member 800 may extend downward out of the housing 500; when the housing 500 and the base 100 are connected, the lower end of the support member 800 abuts against the lower coupling sleeve 120 or the base 100, enabling the lower end of the support member 800 to directly abut against the base 100. Moreover, the number of support members 800 is not limited to the two disclosed in the embodiments and figures. Alternatively, other reasonable numbers, e.g., three or four, may be uniformly distributed along the circumferential direction the electric motor 410 depending on the size of the support members 800. Similarly, the structural form of the support member 800 is not limited to that as illustrated and described herein, which may alternatively adopt other appropriate configurations, such as a cylindrical structure with an aperture.

Referring to FIG. 8, in this embodiment, to ensure stability of the support member 800, the lower connector 520 comprises a connection portion 521 configured to engage with the lower coupling sleeve 120 and a positioning portion 522 arranged on top of the connection portion 521, the outer diameter of the positioning portion 522 being larger than that of the connection portion 521, the lower end of the support member 800 abutting against the positioning portion 522, thereby providing axial constraint to the support member 800. Furthermore, the positioning portion 522 is provided with a positioning block 523 protruding upwardly. The support portion 810 and the positioning block 523 engage to limit the support member 800 radially and circumferentially.

In this embodiment, a first resilient pad 130 is mounted on the underside of the base 100. The first resilient pad 130 has a certain thickness, with its lower surface extending below the underside of the base 100. The first resilient pad 130 enhances the grip of the base 100, thereby improving placement stability of the entire apparatus. The top surface of the lifting head 200 is provided with a second resilient pad 240. The second resilient pad 240 has a certain thickness, with its upper surface being elevated relative to the upper surface of the lifting head 200. The second resilient pad 240 increases the friction between the lifting head 200 and the load 20 supported, thereby improving supporting stability of the apparatus.

Referring to FIG. 9, to facilitate user operation, the housing 500 accommodates a control panel 720 electrically connected to and/or in signal communication with the control board 710. The control panel 720 incorporates a plurality of control elements 730 exposed outside the housing 500, enabling a user to control the apparatus. Specifically, the control elements 730 may be configured as a single element such as a button, a touchscreen, or a knob, or a combination thereof, to meet operational requirements. For example, the control elements 730 include an up button and a down button. The actuator assembly 400 drives the telescoping assembly 300 to extend when the up button is pressed and retracts when the down button is pressed. The battery pack 600 may supply power to electrical components such as the electric motor 410 and the control board 710. The electric motor 410 is governed by the control board 710, which issues commands based on user input to operate the electric motor 410. This enables the lead screw 310 to rotate in a first or second direction, allowing the supported load 20 to ascend or descend.

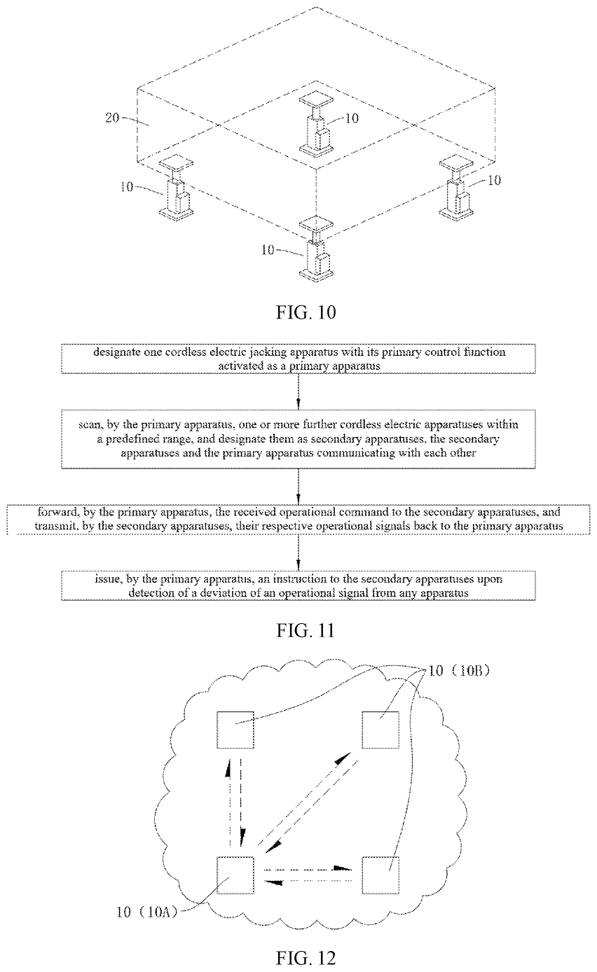

Referring to FIG. 10, when the load 20 has a large size or weight, multiple apparatuses are usually used in coordination to lift or lower the load 20. To ensure stability during lifting/lowering, the apparatuses are desired to move synchronously, maintaining height consistency between their respective lifting heads 200. The load 20 may be an object such as furniture, workpiece, or machinery. As such, each cordless electric jacking apparatus 10 according to this embodiment is provided with a wireless communication unit 750. The apparatuses can communicate directly or indirectly via the wireless communication unit 750 to achieve synchronized movement. Specifically, the wireless communication unit 750 is mounted on the control board 710; the control board 710 communicates with peer apparatuses via the wireless communication unit 750, and the wireless communication unit 750 can also feed a received signal back to the control board 710.

Referring to FIGS. 11 and 12, this embodiment further provides a method of operating the cordless electric jacking apparatus 10 described supra:
designating the cordless electric jacking apparatus 10 upon activation of its primary control function as a primary apparatus 10A, scanning by the primary apparatus 10A for one or more further cordless electric jacking apparatuses 10 within a predefined range, wherein the one or more further cordless electric jacking apparatuses 10 are designated as secondary apparatuses 10B, and communication is established between the primary apparatus 10A and the secondary apparatuses 10B;
forwarding by the primary apparatus 10A an operation command received by the primary apparatus 10A to the secondary apparatuses 10B;
transmitting by the secondary apparatuses 10B their respective operational signals back to the primary apparatus 10A;
and comparing, by the primary apparatus 10A, its own operational signal and the operational signals from the secondary apparatuses 10B with a preset signal value, determining whether any operational signal from any cordless electric jacking apparatus deviates from the preset signal value, and upon determination of such deviation, issuing a command to remaining cordless electric jacking apparatuses.

Specifically, a control panel 720 is provided thereon with a primary control button 740 exposed outside the housing 500. When the primary control button of a cordless electric jacking apparatus 10 is pressed, the apparatus is designated as the primary apparatus 10A. The predefined range is determined by a communication distance of the wireless communication unit 750. The wireless communication unit 750 may employ a Bluetooth communication mode, with its maximum communication range being set to a reasonable value such as 6 m, 8 m, 10 m, 12 m, 14 m, 16 m, 18 m, or 20 m. In other exemplary embodiments of the present application, the wireless communication unit 750 may employ other reasonable wireless communication modes, such as ZigBee or Wi-Fi.

One or more further wireless communication-enabled cordless electric jacking apparatuses 10 within the predefined range are designated as secondary apparatuses 10B. Each secondary apparatus 10B establishes bidirectional communication with the primary apparatus 10A. When a user operates the control element 730 of the primary apparatus 10A to issue a command for lifting or lowering the load 20, the primary apparatus 10A forwards the operational command to the secondary apparatuses 10B via wireless communication, thereby enabling all apparatuses to synchronously lift or lower the load. The secondary apparatuses 10B responsively transmit their respective operational signals to the primary apparatus 10A via wireless communication. The operational signal refers to a single signal or a combined signal that directly or indirectly characterizes the moving speed of the lifting head 200, including but not limited to: current signal of the electric motor 410, voltage signal of the electric motor 410, rotational speed signal of the electric motor 410, rotational speed signal of the torque output member 430, rotational speed signal of any rotating component within the gearbox 420, or moving speed signal of the lifting head 200. Each cordless electric jacking apparatus 10 is provided with a preset signal value. The primary apparatus 10A compares its own operational signal and the operational signals received from the secondary apparatuses 10B against their respective preset signal values. When the operational signal of any apparatus deviates from or exceeds a predetermined threshold relative to its corresponding preset signal value, the primary apparatus 10A transmits a command to the remaining secondary apparatuses 10B. For example, if the lifting or lowering speed of one or more apparatuses falls below the preset speed value, the primary apparatus 10A transmits a command to the remaining secondary apparatuses 10B to reduce their operating speed. Upon receiving the command, each secondary apparatus 10B instructs its electric motor 410 to reduce rotational speed via its control board 710, thereby reducing the lifting or lowering speed.

It is to be understood that, in this embodiment, the maximum load-bearing capacity of the cordless electric jacking apparatus 10 may be set to a reasonable value, for example, 20 kg, 30 kg, 40 kg, 50 kg, 60 kg, 70 kg, 80 kg, 90 kg, or 100 kg, based on factors including model of the electric motor 410, load-bearing capacity of the gearbox 420, load-bearing capacity of the telescoping assembly 300, and operating voltage of the battery pack 600.

It is to be understood that the connecting structure 101 between the housing 500 and the base 100 is not limited to the configurations described herein and illustrated in the drawings; and other reasonable connection means may also be employed, for example, a ball bearing hinge-type connection or other equivalent structures.

It is to be understood that the lower connector 520 and the lower coupling sleeve 120 may be removably connected by means other than threaded engagement, for example, via square drive coupling (analogous to coupling between a square drive head and a socket in a torque wrench), or other functionally equivalent detachable mechanisms.

It is to be understood that the top end of the inner tube 330 and the upper coupling sleeve 220 may also be removably connected by alternatives to threaded engagement, for example, square drive coupling (analogous to coupling between a square drive head and a socket in a torque wrench), or other functionally equivalent detachable configurations.

### Second Embodiment

This embodiment differs from the first embodiment in that the support member 800 is disposed on an exterior side of the electric motor 410 and the gearbox 420; the lower end of the telescoping assembly 300 directly or indirectly abuts against the upper end of the support member 800; and the lower end of the support member 800 directly or indirectly abuts against the base 100.

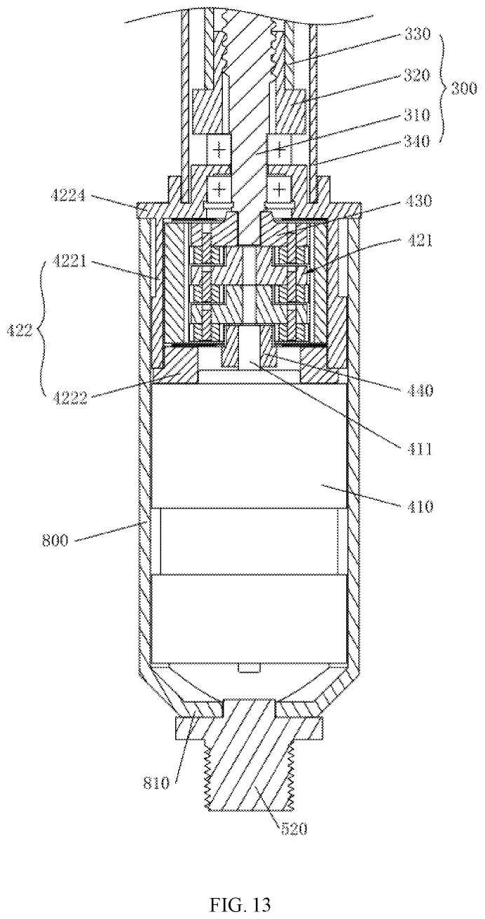

Referring to FIG. 13, in the first configuration of this embodiment, a top wall of the gearbox shell 4221 is provided with a flange 4224 protruding circumferentially radially outward. The top end of the support member 800 abuts against the flange 4224. The outer tube 340 of the telescoping assembly 300 abuts against the top wall of the gearbox shell 4221 which in turn abuts against the upper end of the support member 800, thereby causing the lower end of the telescoping assembly 300 to indirectly abut against the upper end of the support member 800. The lower end of the support member 800 may still abut against the lower connector 520 via the support portion 810, thereby enabling the lower end of the support member 800 to indirectly abut against the base 100.

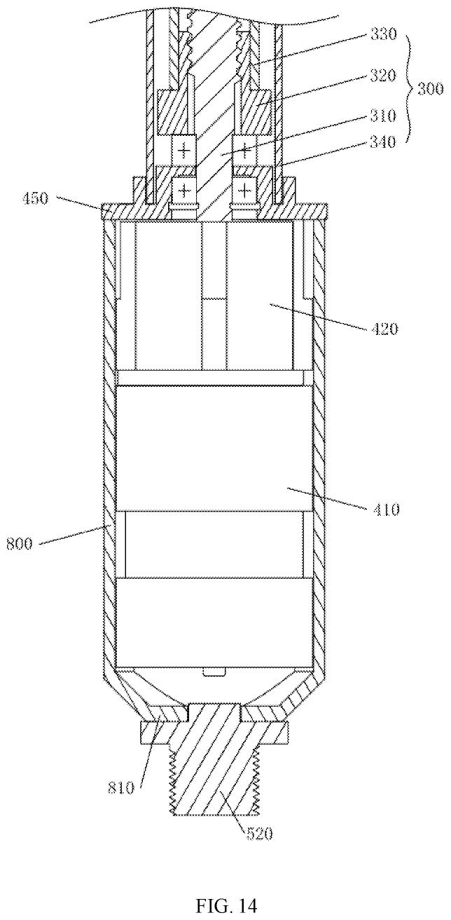

Referring to FIG. 14, in the second configuration of this embodiment, a support disc 450 is provided on top of the gearbox 420. The lower end of the outer tube 340 abuts against the support disc 450 and is constrained by the latter, while the upper end of the support member 800 abuts against the underside of the support disc 450, i.e., the lower end of the telescoping assembly 300 indirectly abuts against the upper end of the support member 800 via the support disc 450. Of course, the support disc 450 and the support member 800 may be integrally formed or separately formed and subsequently secured together.

In this embodiment, the support member 800 may be configured as an arc-shaped plate-like structure, a plurality of the support member 800 being arranged circumferentially at intervals around the actuator assembly 400; alternatively, the support member 800 is configured as a cylindrical structure with cutout openings.

In an alternative embodiment of the present application, components such as an elastic pad or a rigid support ring may be disposed between the upper end of the support member 800 and the support disc 450.

In a further alternative embodiment of the present application, the lower end of the support member 800 may extend downward out of the housing; when the housing is connected to the base, the lower end of the support member 800 may directly abut against the base or directly abut against the lower coupling sleeve.

The remaining structural features of the second embodiment are identical to those of the first embodiment, which are thus not repeated herein.

The operating method described in the first embodiment is applicable to the cordless electric jacking apparatus of this embodiment.

### Third Embodiment

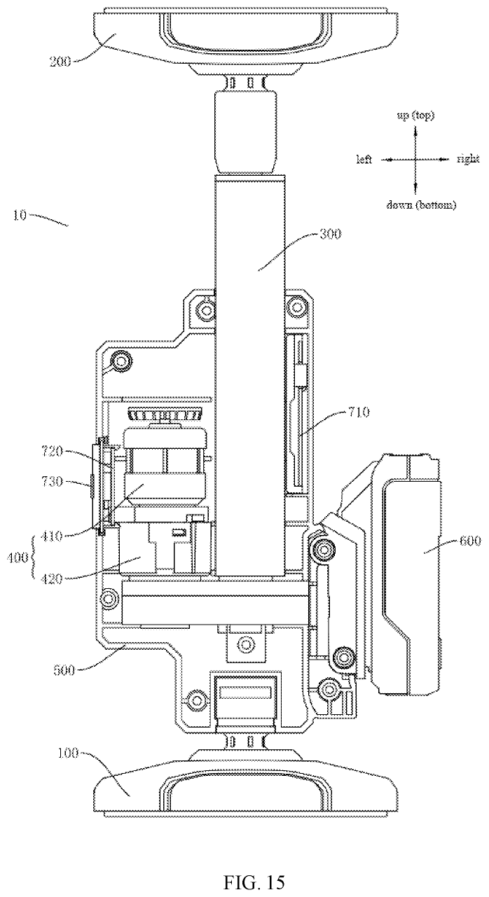

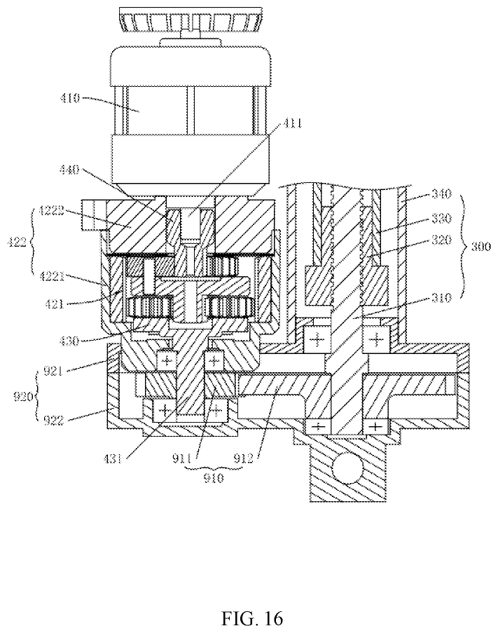

Referring to FIGS. 15 and 16, this embodiment differs from the first embodiment in that the actuator assembly 400 is disposed laterally adjacent to the telescoping assembly 300, the torque output member 430 of the actuator assembly 400 is oriented downward and drivingly connected to the telescoping assembly 300 via a transmission unit 910.

Specifically, the electric motor 410 is mounted on top of the gearbox 420, with the lower end of its drive shaft 411 projecting into the gearbox 420 as the torque input member. A reduction mechanism 421 is provided in the gearbox 420. The reduction mechanism 421 at least comprises one stage of planetary gear reduction structure, with the planetary carrier of the final-stage planetary gear reduction structure serving as the torque output member 430, the torque output member 430 being disposed on an inner bottom of the gearbox 420 and featuring a downward-extending output shaft 431; the output shaft 431 and the planetary carrier of the final-stage planetary gear reduction structure may be integrally formed, or separately formed and subsequently secured together. The transmission unit 910 comprises a driving gear 911 sleeved on the output shaft 431 and a driven gear 912 sleeved on the lower end of the lead screw 310, the driving gear 911 and the driven gear 912 meshing with each other. The electric motor 410 drives the torque output member 430 to rotate via the reduction mechanism 421 in the gearbox 420, and the torque output member 430 rotates the lead screw 310 via meshing engagement between the driving gear 911 and the driven gear 912, thereby achieving torque output. In this embodiment, the central axes of the electric motor 410 and gearbox 420 are substantially aligned, i.e., the electric motor 410 and the gearbox 420 are substantially coaxially arranged, and the central axis of the telescoping assembly 300 is parallel to the central axis of the actuator assembly 400 with a predetermined distance therebetween.

The transmission unit 910 is exteriorly provided with an outer casing 920, i.e., the transmission unit 910 is housed within the outer casing 920, and the outer casing 920 is disposed at bottom regions of the gearbox 420 and the telescoping assembly 300; the lower end of the output shaft 431 and the lower end of the lead screw 310 both project into the outer casing 920; the lower end of the outer tube 340 abuts against a top portion of the outer casing 920; the outer casing 920 is mounted within the housing 500. In this configuration, the telescoping assembly 300 transfers the load from the lifting head 200 to the outer casing 920, which then transmits the load to the base 100 via the housing 500.

To balance the weight of the apparatus, the battery pack 600, when attached to the housing 500, and the actuator assembly 400 are substantially symmetrically distributed about the telescoping assembly 300 in the transverse direction. For example: the battery pack 600 attached to the housing 500 is disposed to the right of the telescoping assembly 300; the actuator assembly 400 is disposed to the left of the telescoping assembly 300. This symmetrical arrangement achieves weight balance and thus enhances overall stability of the apparatus.

In an alternative configuration of this embodiment, the transmission unit 910 may also be replaced with a belt drive mechanism or other suitable transmission means.

In another alternative configuration of this embodiment, the battery pack 600 and actuator assembly 400 may also be distributed asymmetrically.

The remaining structural features of the third embodiment are identical to those of the first embodiment, which are thus not repeated here.

The operating method described in the first embodiment is applicable to the cordless electric jacking apparatus 10 of this embodiment.

### Fourth Embodiment

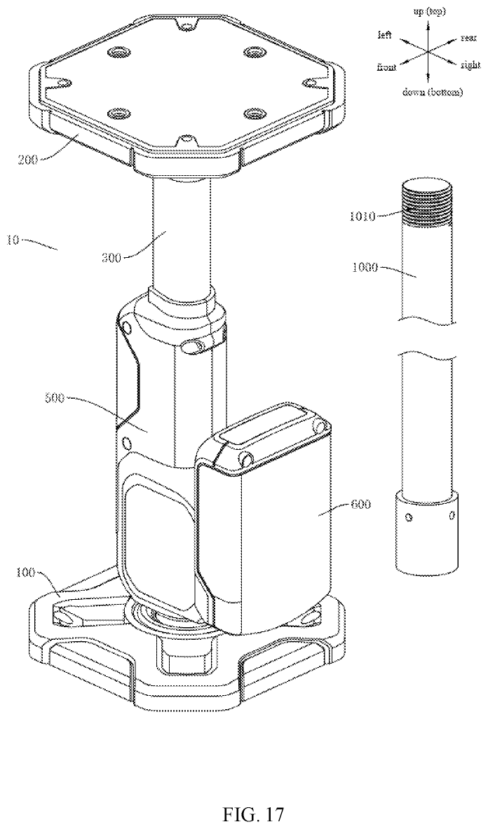

Referring to FIG. 17, the cordless electric jacking apparatus 10 of the present embodiment comprises:
a base 100;
a lifting head 200 disposed over the base 100;
a telescoping assembly 300 disposed between the base 100 and the lifting head 200 and configured to drive the lifting head 200 to ascend or descend relative to the base 100;
an actuator assembly 400 configured to deliver torque to the telescoping assembly 300 to extend or retract the telescoping assembly 300;
a housing 500 disposed between the base 100 and the lifting head 200, the telescoping assembly 300 and the actuator assembly 400 each being at least partially received within the housing 500;
a battery pack 600 removably attached to the housing 500 and configured to supply power at least to the actuator assembly 400, the center of gravity of the battery pack 600 attached to the housing 500 falling within the vertical projection range of the base 100;
and an extension rod 1000 removably installed either between the telescoping assembly 300 and the lifting head 200 or between the housing 500 and the base 100, or both.

The extension rod 1000 may effectively extend a lifting height range of the apparatus the user can determine whether to install the extension rod 1000 based on specific operational requirements.

Other structural features of the cordless electric jacking apparatus 10 except for the extension rod 1000 are identical to those of the first embodiment, which are thus not repeated here.

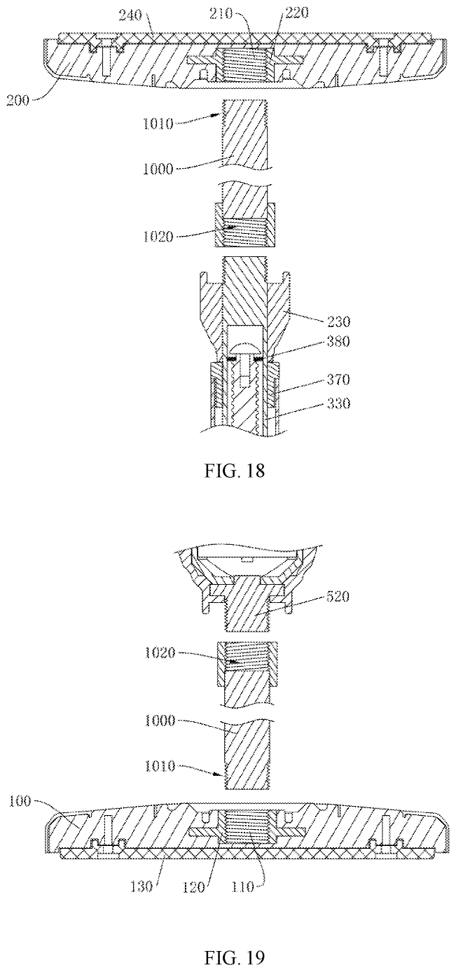

To facilitate installation of the extension rod 1000, a same connection structure may be applied to implement a detachable connection between the telescoping assembly 300 and the lifting head 200, between the housing 500 and the base 100, between the extension rod 1000 and the telescoping assembly 300, between the extension rod 1000 and the lifting head 200, between the extension rod 1000 and the housing 500, and between the extension rod 1000 and the base 100. This configuration allows the same extension rod 1000 to be installed either between the telescoping assembly 300 and the lifting head 200 or between the housing 500 and the base 100, thereby enhancing universality of the extension rod 1000. In this embodiment, one end of the extension rod 1000 features an externally threaded section 1010, and the opposite end features an internally threaded section 1020. As illustrated in FIGS. 18 and 19, the externally threaded section 1010, the external thread on the top end of the inner tube 330, and the external thread on the lower connector 520 share a same specification. Similarly, the internally threaded section 1020, the upper mounting hole 210, and the lower mounting hole 110 also have a same specification. When the extension rod 1000 is installed between the telescoping assembly 300 and the lifting head 200, the externally threaded section 1010 of the extension rod 1000 is screwed into the upper mounting hole 210, and the external thread on the top end of the inner tube 330 is screwed into the internally threaded section 1020 of the extension rod 1000. When the extension rod 1000 is installed between the housing 500 and the base 100, the externally threaded section 1010 of the extension rod 1000 is screwed into the lower mounting hole 110, and the lower connector 520 is screwed into the internally threaded section 1020 of the extension rod 1000.

In an alternative embodiment of the present disclosure, the detachable connections between the telescoping assembly 300 and the lifting head 200, between the housing 500 and the base 100, between the extension rod 1000 and the telescoping assembly 300, between the extension rod 1000 and the lifting head 200, between the extension rod 1000 and the housing 500, and between the extension rod 1000 and the base 100 may also adopt an alternative configuration in replacement of threaded engagement, for example, square drive coupling (analogous to coupling between a square drive head and a socket in a torque wrench).

The operating method described in the first embodiment is applicable to the cordless electric jacking apparatus of this embodiment.

### Fifth Embodiment

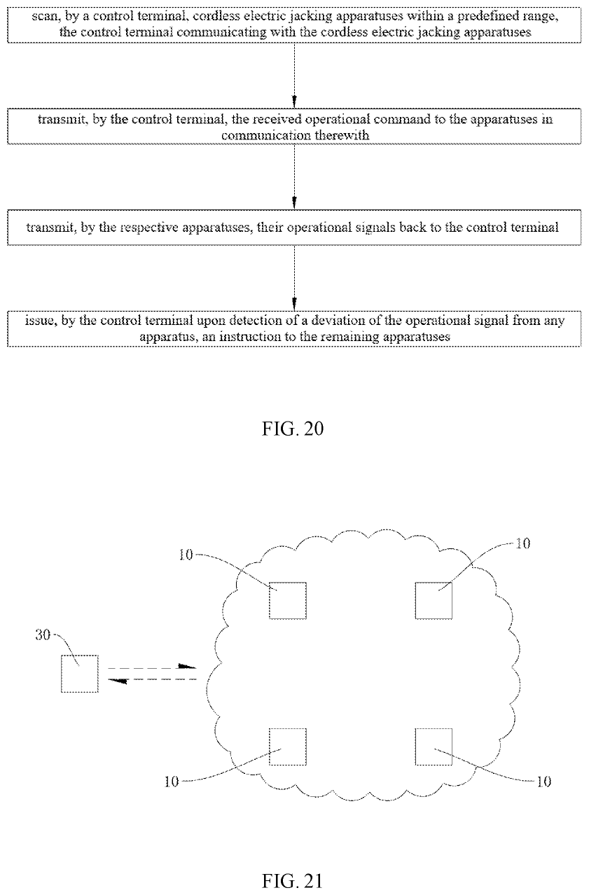

Referring to FIGS. 20 and 21, in this embodiment, the cordless electric jacking apparatus 10 is configured with a control terminal 30. An operational method for the cordless electric jacking apparatus comprises:
scanning, by the control terminal 30, for one or more cordless electric jacking apparatuses 10 within a predefined range, and establishing communication with the one or more cordless electric jacking apparatuses 10;
transmitting, by the control terminal 30, an operational command to the one or more cordless electric jacking apparatuses 10 in communication with the control terminal 30;
transmitting, by the one or more cordless electric jacking apparatuses 10, their respective operational signals back to the control terminal 30, and receiving, by the control terminal 30, operational signals from the one or more cordless electric jacking apparatuses 10; and detecting whether any operational signal from any cordless electric jacking apparatus 10 deviates from a preset signal value, and upon detection of such deviation, transmitting an instruction to each of the remaining cordless electric jacking apparatuses 10.

In this embodiment, the control terminal 30 may be an independent controller with remote operation functionality or an electronic device such as a mobile phone or a tablet computer installed with corresponding operation software. The user may send a lifting or lowering command to the connected apparatus via the control terminal 30, and then the apparatus instructs the electric motor 410 to operate upon receiving the command. Each apparatus transmits an operational signal indicative of its motion speed to the control terminal 30. The control terminal 30 compares the operational signals of respective apparatuses with preset signal values. If the motion speed of one apparatus is lower than that of others, the control terminal 30 issues a command to the other apparatuses to reduce their speed or pause their operation, and the other apparatuses execute the corresponding operation upon receiving the command.

The cordless electric jacking apparatus 10 of this embodiment may be the apparatus described in the first, second, third, or fourth embodiment.

Other features of the fifth embodiment are identical to those of the first embodiment, which are thus not repeated here.

### Sixth Embodiment

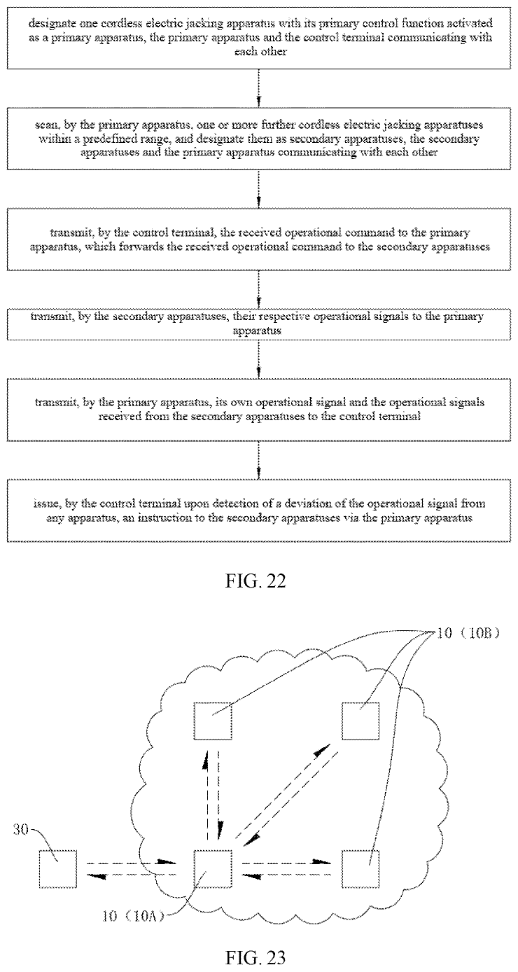

Referring to FIGS. 22 and 23, in this embodiment, the cordless electric jacking apparatus 10 is configured with a control terminal 30, and a method for collaboratively controlling multiple cordless electric jacking apparatuses 10 comprises:
activating a primary control function of one cordless electric jacking apparatus 10 to designate it as primary apparatus 10A, and establishing bidirectional communication between the primary apparatus 10A and the control terminal 30;
scanning, by the primary apparatus 10A, for one or more further cordless electric jacking apparatuses 10 within a predefined range, and designating the one or more further cordless electric jacking apparatuses 10 as secondary apparatuses 10B and establishing communication between the primary apparatus 10A and the secondary apparatuses 10B;
transmitting, by the control terminal 30, an operational command to the primary apparatus 10A, and forwarding, by the primary apparatus 10A, the received operational command to the secondary apparatuses 10B;
transmitting, by the secondary apparatuses 10B, their respective operational signals to the primary apparatus 10A, transmitting, by the primary apparatus 10A, its own operational signal and the operational signals received from the secondary apparatuses 10B to the control terminal 30, and issuing, by the control terminal 30, a control command to the secondary apparatuses 10B via the primary apparatus 10A upon detecting a deviation of any operational signal from a preset signal value.

In this embodiment, the control terminal 30 may be an independent controller with remote operation functionality or an electronic device such as a mobile phone or a computer installed with corresponding operational software. The user can send a lifting or lowering command to the connected primary apparatus 10A via the control terminal 30, the primary apparatus 10A forwards the operational command to the secondary apparatuses 10B, and then the secondary apparatuses 10B each instruct their electric motor 410 to operate upon receiving the command. The secondary apparatuses 10B transmit their respective operational signals indicative of their motion speeds to the primary apparatus 10A. The primary apparatus 10A transmits its own operational signal and those from the secondary apparatuses 10B back to the control terminal 30. The control terminal 30 compares these signals with a preset signal value. When the motion speed of one apparatus is lower than that of others, the control terminal 30 issues, via the primary apparatus 10A, a command to slow down or pause to the primary apparatus 10A itself or the secondary apparatuses 10B, and the receiving apparatuses execute the command accordingly. In this embodiment, the primary apparatus 10A acts as a relay between the control terminal 30 and the secondary apparatuses 10B.

In an alternative configuration of this embodiment, the secondary apparatuses 10B transmit their respective operational signals back to the primary apparatus 10A. When an anomaly occurs in one apparatus, the primary apparatus 10A directly issues a command to slow down or pause to itself or the other apparatuses, and the receiving apparatuses execute the corresponding command responsively.

The cordless electric jacking apparatus 10 of this embodiment may be the apparatus described in the first, second, third, or fourth embodiment.

Other features of the sixth embodiment are identical to those of the first embodiment which are thus not repeated here.

In addition to the exemplary embodiments described supra, the present disclosure further has other embodiments. Various changes and modifications made by those skilled in the art based on the present disclosure shall all fall within the scope defined in the appended claims without departing from the spirit of the present disclosure.

1. A cordless electric jacking apparatus, comprising:
a base;
and a lifting head disposed over the base;
wherein the cordless electric jacking apparatus further comprises:
a telescoping assembly disposed between the base and the lifting head and configured to drive the lifting head to ascend or descend relative to the base;
an actuator assembly configured to deliver torque to the telescoping assembly to extend or retract the telescoping assembly;
a housing disposed between the base and the lifting head and configured to at least partially house the telescoping assembly and the actuator assembly;
and a battery pack removably attached to the housing and configured to supply power to at least the actuator assembly, wherein the center of gravity of the battery pack, when attached to the housing, lies within the vertical projection range of the base.

2. The cordless electric jacking apparatus according to claim 1, wherein the battery pack attached to the housing lies within the vertical projection range of the base; and/or the lifting head lies within the vertical projection range of the base.

3. The cordless electric jacking apparatus according to claim 1, wherein the housing is provided with a receiving portion configured to mate with the battery pack, the battery pack being inserted from above into the receiving portion to attach to the housing.

4. The cordless electric jacking apparatus according to claim 3, wherein the receiving portion is disposed in a lower portion of a side wall of the housing; and/or the center of gravity of the battery pack, when attached to the housing, lies at or below a height-center line of the cordless electric jacking apparatus in its fully retracted state.

5. The cordless electric jacking apparatus according to claim 1, wherein the actuator assembly is disposed below the telescoping assembly, and a torque output member of the actuator assembly is oriented upward and drivingly connected to the telescoping assembly.

6. The cordless electric jacking apparatus according to claim 5, wherein the actuator assembly and the telescoping assembly are coaxially arranged; and/or the actuator assembly comprises an electric motor and a gearbox mounted on top of the electric motor, and a support member is disposed inside the housing positioned externally to at least a portion of the actuator assembly, the support member being configured to at least prevent the electric motor from bearing a load force.

7. The cordless electric jacking apparatus according to claim 1, wherein the actuator assembly is disposed laterally adjacent to the telescoping assembly, and a torque output member of the actuator assembly is oriented downward and drivingly connected to the telescoping assembly via a transmission unit.

8. The cordless electric jacking apparatus according to claim 7, wherein the battery pack attached to the housing and the actuator assembly are symmetrically distributed about the telescoping assembly.

9. A cordless electric jacking apparatus, comprising:
a base;
and a lifting head disposed over the base;
wherein the cordless electric jacking apparatus further comprises:
a telescoping assembly disposed between the base and the lifting head and configured to drive the lifting head to ascend or descend relative to the base;
an actuator assembly configured to deliver torque to the telescoping assembly to extend or retract the telescoping assembly;
a housing disposed between the base and the lifting head and configured to at least partially house the telescoping assembly and the actuator assembly;
a battery pack removably attached to the housing and configured to supply power to at least the actuator assembly, wherein the center of gravity of the battery pack, when attached to the housing, lies within the vertical projection range of the base;
and an extension rod removably installed either between the telescoping assembly and the lifting head or between the housing and the base, or both.

10. The cordless electric jacking apparatus according to claim 9, wherein a same connection structure is employed to provide detachable connection between the telescoping assembly and the lifting head, between the housing and the base, between the extension rod and the telescoping assembly, between the extension rod and the lifting head, between the extension rod and the housing, and between the extension rod and the base.

11. A method of operating the cordless electric jacking apparatus according to claim 1, the cordless electric jacking apparatus being provided with a wireless communication unit, the method comprising:
designating the cordless electric jacking apparatus, upon activation of its primary control function, as a primary apparatus, scanning, by the primary apparatus, for one or more further cordless electric jacking apparatuses within a predefined range, wherein the one or more further cordless electric jacking apparatuses are designated as secondary apparatuses, and communication is established between the primary apparatus and the secondary apparatuses;
forwarding, by the primary apparatus, an operational command received by the primary apparatus to the secondary apparatuses;
transmitting, by the secondary apparatuses, their respective operational signals back to the primary apparatus;
and comparing, by the primary apparatus, its own operational signal and the operational signals from the secondary apparatuses with a preset signal value, determining whether any operational signal from any cordless electric jacking apparatus deviates from the preset signal value, and upon determination of such deviation, issuing a command to remaining cordless electric jacking apparatuses.

12. A method of operating the cordless electric jacking apparatus according to claim 1, the cordless electric jacking apparatus being provided with a wireless communication unit and configured to communicate with a control terminal, the method comprising:
scanning, by the control terminal, for one or more cordless electric jacking apparatuses within a predefined range, and establishing communication with the one or more cordless electric jacking apparatuses;
transmitting, by the control terminal, an operational command to the one or more cordless electric jacking apparatuses in communication with the control terminal;
transmitting, by the one or more cordless electric jacking apparatuses, their respective operational signals back to the control terminal,
and receiving, by the control terminal, operational signals from the one or more cordless electric jacking apparatuses; and detecting whether any operational signal from any cordless electric jacking apparatus deviates from a preset signal value, and upon detection of such deviation, transmitting an instruction to each of the remaining cordless electric jacking apparatuses.

13. A method of operating the cordless electric jacking apparatus according to claim 1, the cordless electric jacking apparatus being provided with a wireless communication unit and configured to communicate with a control terminal, the method comprising:
designating the cordless electric jacking apparatus, upon activation of its primary control function, as a primary apparatus and establishing communication between the primary apparatus and the control terminal;
scanning, by the primary apparatus, for one or more further cordless electric jacking apparatuses within a predefined range; designating the one or more further cordless electric jacking apparatuses as secondary apparatuses and establishing communication between the secondary apparatuses and the primary apparatus;
transmitting, by the control terminal, an operational command to the primary apparatus;
and forwarding, by the primary apparatus, the operational command to the secondary apparatuses.

14. The method according to claim 13, wherein:
the secondary apparatuses transmit their respective operational signals back to the primary apparatus; the primary apparatus forwards its own operational signal and the operational signals from the secondary apparatuses to the control terminal; and the control terminal, upon detecting any deviation of any operational signal from any cordless electric jacking apparatus from a preset signal value, transmits an instruction to the primary apparatus itself or any of the remaining secondary apparatuses via the primary apparatus;
or
the secondary apparatuses transmit their respective operational signals back to the primary apparatus; and the primary apparatus, upon detecting any deviation of any operational signal from any cordless electric jacking apparatus from a preset signal value, issues an instruction to any of the remaining cordless electric jacking apparatuses.
